(19) United States
(12) Patent Application Publication
(10) Pub. No.: US 2014/0089208 A1
(43) Pub. Date: Mar. 27, 2014

(54) SYSTEMS AND METHODS FOR EVALUATING REPAIRS TO VEHICLES

(71) Applicant: Manheim Investments, Inc., Atlanta, GA (US)

(72) Inventors: Mark William Humble, Nashville, TN (US); Marc Erdreich Haegelin, Mount Juliet, TN (US); Michael Allan Chastain, Laurelville, OH (US); Julie Elizabeth Warpool, Nolensville, TN (US)

(73) Assignee: Manheim Investments, Inc., Atlanta, GA (US)

(21) Appl. No.: 14/022,968

(22) Filed: Sep. 10, 2013

Related U.S. Application Data
(60) Provisional application No. 61/704,887, filed on Sep. 24, 2012.

(51) Int. Cl. G06Q 10/00

(52) U.S. Cl. CPC G06Q 10/20
USPC 705/305

(57) ABSTRACT

Systems and methods for evaluating repairs or combinations of repairs for one or more vehicles are provided herein. In certain embodiments, a seller may select one or more possible repairs or combinations of repairs to done on a vehicle or group of vehicles. Based on the selected repairs, a change in the overall value of the vehicle(s) may be determined In addition, as the seller selects the one or more repairs, the impact that making other repairs will have on the overall value of the vehicle(s) may be adjusted.

### CROSS REFERENCE TO RELATED APPLICATION

This application claims priority to and the benefit of U.S. provisional patent application Ser. No. 61/704,887, entitled “SYSTEMS AND METHODS FOR EVALUATING REPAIRS TO VEHICLES,” filed Sep. 24, 2012, which is hereby incorporated by reference in its entirety.

### BACKGROUND

Reconditioning vehicles for sale, such as at wholesale auctions and/or retail sales lots, requires intuition and knowledge as to whether the costs and time associated with making one or more repairs to a vehicle sufficiently increases the overall value of the vehicle to meet the objectives of a seller. Often, a seller's intuition can be wrong in making such a determination. Additionally, fully understanding sales markets for multiple vehicle types, in multiple markets, and the associated cost benefit of making repairs can be an exhausting and oftentimes futile task. Incorrect decisions and/or cost benefit analyses can lead to repairs that provide little, if any, value to the vehicle and/or do not meet the seller's objectives. Thus, finding ways to provide sellers with accurate information for evaluating the impact of possible repairs on the overall value of a vehicle continues to be a priority.

### BRIEF DESCRIPTION OF THE DRAWINGS

The detailed description is set forth with reference to the accompanying drawings, which are not necessarily drawn to scale. In the figures, the left-most digit(s) of a reference number identifies the figure in which the reference number first appears. The same reference numbers in different figures indicate similar or identical items.

FIG. 1 is a block diagram of an illustrative system for evaluating repairs to vehicles, according to an illustrative embodiment.

FIGS. 2A, 2B, and 2C are illustrative user application interfaces for evaluating repairs to vehicles, according to an illustrative embodiment.

FIG. 3 is a flow diagram illustrating details of a method of evaluating repairs to vehicles, according to an illustrative embodiment.

FIG. 4 is a flow diagram illustrating details of a method of evaluating repairs to vehicles, according to an illustrative embodiment.

### DETAILED DESCRIPTION

### Overview

Illustrative embodiments of the disclosure will now be described more fully hereinafter with reference to the accompanying drawings, in which some, but not all embodiments of the disclosure are shown. The systems and methods described herein may be embodied in many different forms and should not be construed as limited to the embodiments set forth herein; rather, these embodiments are provided so that this disclosure will satisfy applicable legal requirements. As noted above, like numbers refer to like elements throughout.

Illustrative embodiments of the disclosure are directed to, among other things, systems and methods for determining a change in the overall value and/or profitability of a vehicle based on implementing one or more possible repairs to the vehicle. As an overview, sellers generally do not know what the impact of individual repairs or combinations of repairs will be on the overall value and/or profitability of a vehicle. The systems and methods described herein, however, enable sellers to appreciate and evaluate the impact that one or more repairs or combinations of repairs may have on the overall value and/or profitability of a vehicle. In this manner, the sellers may make an informed decision on which repairs or combination of repairs to implement to meet the sellers' objectives.

A reconditioning management solution is provided. According to an example embodiment, the reconditioning management solution may have access to complete, or near compete, data associated with damage that exists on a vehicle that a seller would like to sell. In some instances, the damage data associated with a vehicle may be provided by one or more third parties, such as a vehicle history report provider. In other instances, the damage data associated with a vehicle may be provided by the seller. In yet other instances, the damage data may be provided by an inspector who performs a vehicle condition inspection. In some instances, this damage inspection may be partially or fully automated. The term damage encompasses, without limitation, anything that may affect the condition, value, and/or profitability of a vehicle. For instance, damage may include, but is not limited to, conditions such as scratches, dents, rust, missing parts, unaddressed recalls or updates, and/or mechanical issues for which repair may be desirable. Further, the reconditioning management solution may have access to complete, or near compete, data related to the costs of making repairs to the damage. In some instances, the repair costs may come from third parties and may include standard industry pricing, such as Mitchell pricing or the like. In other instances, the sellers may provide their own repair costs. For example, certain sellers may have their own repair facilities as well as their own database of proprietary repair cost data that they may want to use in assessing the impact of making repairs.

The reconditioning management solution may be accessible over a public or private network, such as the Internet, by one or more automobile sellers or their agents. The sellers, according to an example embodiment, may interact with a server, or other computing device, of the reconditioning management solution by way of software implementation on a computing device of the seller and/or via a Web application of the reconditioning management solution. In some instances, the reconditioning management solution may be implemented as a dedicated application on a computing device and/or a server based application accessible by the computing device via a browser application or a dedicated application on the computing device, whereby the dedicated application may perform at least some of the operations of the reconditioning management solution. In certain embodiments, the sellers may select, via the web application interface to the reconditioning management solution, for example, one or more possible repairs or combinations of repairs to be done to the vehicle. The reconditioning management solution may dynamically determine a change in the overall value and/or profitability of the vehicle based on the selected repairs to the vehicle. In some instances, as the seller selects one or more repairs, the reconditioning management solution may also dynamically adjust (or modify) the impact that making other repairs will have on the overall value and/or profitability of the vehicle. The overall value and/or profitability of the vehicle may include the wholesale value and/or the retail value of the vehicle. In this way, the seller can iteratively examine the impact of the various repairs and then determine the repairs or combinations of repairs, if any, that they think are most appropriate.

In some instances, evaluating the various repairs or combinations of repairs and the associated costs for each vehicle individually to determine the overall increase in value and/or profitability can be time consuming Accordingly, in certain embodiments, instead of requiring the seller to iteratively work through the potential repairs or combinations of repairs, the reconditioning management solution can be configured to do it automatically. For example, in an embodiment, the seller can enter a reconditioning budget. The reconditioning management solution can then identify all of the possible repairs or combinations of repairs that can be made within the reconditioning budget and provide a list of the repairs or combinations of repairs ranked by how much they improve the overall value or profitability of the vehicle. In this manner, the seller can simply look at the list of repairs or combinations of repairs and decide what repairs or combinations of repairs they prefer.

In another embodiment, the seller can enter a target overall value and/or profitability of a vehicle. The reconditioning management solution can then identify all of the repairs or combinations of repairs that will raise the overall value and/or profitability of the vehicle to meet and/or exceed the target value and/or profitability of the vehicle. In some instances, the repairs or combinations of repairs can be listed and ranked by the cost associated with each. In other instances, the repairs or combinations of repairs can be ranked based on the number of individual repairs necessary to meet and/or exceed the target value and/or profitability of the vehicle. In still other instances, the seller can enter a reconditioning budget and a target overall value and/or profitability of a vehicle, with the reconditioning management solution determining and ranking the repairs or combinations of repairs that meet and/or exceed the entered parameters. Further, in another embodiment, the reconditioning management solution can be configured to identify and provide the sellers with a list of repairs or combinations of repairs that most improve the profitability of selling the vehicle, i.e., the repairs or combinations of repairs that generate the biggest difference between, for example, the projected auction price or retail price of the vehicle and the cost of making the repairs.

In an example embodiment, the reconditioning management solution may be configured to identify all of the repairs or combinations of repairs that are required by a certifying authority (such as an original equipment manufacturer (OEM) or the like) for designating a vehicle as a certified pre-owned (CPO) vehicle. For example, OEMs (or other certifying authorities) may have certain requirements for designating a vehicle as a CPO vehicle. In this manner, in order for the vehicle to meet the OEM's standards, the seller may be required to make certain repairs. In some instances, if a vehicle is designated by the seller as a possible CPO vehicle, the reconditioning management solution can identify all of the repairs or combinations of repairs that are required by the OEM to obtain CPO status. Further, in certain embodiments, the reconditioning management solution may be configured to identify the profitability of CPO vehicles verses other seller options. For example, based on the repairs or combinations of repairs, the reconditioning management solution may provide the seller with the projected value and/or profitability of the vehicle as a CPO vehicle or as a non-CPO vehicle.

In some instances, the seller may filter (or limit) the repairs identified by the reconditioning management solution. For example, some sellers may not wish to perform certain repairs or may not have the capability to perform certain repairs. In this manner, the seller may exclude certain repairs from being presented to the seller by the reconditioning management solution. The seller also may exclude certain repairs from being considered by the reconditioning management solution when determining the repairs or combinations of repairs that are within the reconditioning budget. Moreover, the seller may exclude certain repairs from being considered that may raise the overall value and/or profitability of the vehicle to meet and/or exceed the target value and/or profitability of the vehicle and/or that are required to meet CPO vehicle standards.

In certain embodiments, the reconditioning management solution may be configured to identify and provide the seller with a range of typical values, such as the typical sales price, for the relevant make and model of the vehicle at auction and/or retail. For example, certain repairs or combinations thereof may affect the retail and/or wholesale value differently. The seller can then select and/or enter the wholesale auction value and/or the retail value that the seller is seeking for the vehicle and the reconditioning management solution can determine what, if any, repairs or combinations of repairs will project the value of the vehicle to the desired auction and/or retail value. If the desired value is not possible, the reconditioning management solution may be configured to rank the repairs or combinations of repairs in the order that come closest to achieving the desired value. This could equally be implemented with regard to profitability or the like.

In an example embodiment, the reconditioning management solution may be configured to identify and provide the seller with a listing of one or more repairs of combinations of repairs that are most likely to result in the vehicle selling quickly. That is, the reconditioning management solution may identify one or more repairs or combinations of repairs that are most likely to help the vehicle sell at auction, retail and/or wholesale. For example, if the seller indicates that the vehicle will be sold at a wholesale auction, the reconditioning management solution may be configured to identify one or more repairs or combinations of repairs that will increase the likelihood of the vehicle selling in its first run through the auction lane. In this manner, the seller may avoid having to put the vehicle up for auction more than once.

In certain embodiments, the reconditioning management solution is scalable from an individual vehicle to an inventory of vehicles or subset thereof. That is, a seller can indicate that they want all of their vehicles to be a minimum value, profitability, and/or all repairs or combinations of repairs for each vehicle to be within a maximum cost. For example, the reconditioning management solution may determine what repairs or combinations of repairs, if any, are necessary to achieve the minimum value. In some instances, the repairs or combinations of repairs necessary to achieve the minimum value may be presented on a vehicle-by-vehicle basis, with the least expensive repairs or combinations of repairs being listed first for each vehicle. In other instances, the reconditioning management solution may be linked to an associated repair system that automatically orders the least expensive repairs or combinations of repairs to achieve the minimum value and/or profitability. For example, the reconditioning management solution may include decision making functionality. That is, a seller may define a set of repair parameters for one or more vehicles, such as overall vehicle value, profitability, timing, repairs costs, CPO certification, or the like, and the reconditioning management solution may automatically determine (e.g., via one or more algorithms) one or more repairs or combinations of repairs that meet the defined parameters. In some instances, the one or more repairs or combinations of repairs may be automatically approved by the reconditioning management solution, i.e., the vehicle(s) may be sent for repairs without any human approval.

As noted above, just as the seller can decide on a minimum value, the seller can also set a maximum repair budget per vehicle. Moreover, the seller can also set a desired increase in auction and/or retail sales value or profitability for each vehicle or the entire inventory of vehicles. For example, the reconditioning management solution may be configured to analyze all of the vehicles in the inventory and make a vehicle-by-vehicle determination of how to best achieve the desired objectives of the seller. In some instances, the maximum repair budget can be per vehicle, or it can be for all of the vehicles in the inventory. For example, the reconditioning management solution may determine that spending $1,000 repairing a first vehicle and only $50 repairing a second vehicle will achieve the best return and stay within budget.

In another embodiment, the reconditioning management solution may be configured to evaluate how long it will take a recondition facility to make the recommended repairs or combinations of repairs. In this way, the throughput to an auction day or retail lot can be identified. In some instances, for vehicles taken to an auction facility, the costs associated with having the vehicles sitting at auction before sale can also be factored into the total cost that is presented to the sellers, which may further assist the sellers in assess the cost benefit for a repair or combination of repairs. Similar analysis can be performed with regard to wholesale auctions, retail auctions, and/or retail lot sales.

In certain embodiments, the overall value of the vehicle can be associated with a reconditioning score or any other score or measure. In this way, the seller can normalize the value of each vehicle in an inventory of vehicles. Further, in some instances, the overall value of the vehicle can be associated with a valuation score, such as the Manheim Market Report (MMR) score or the like. In this way, the seller can weigh the cost of making any repairs or combinations of repairs against a predicted change in auction value of the vehicle.

### Illustrative Architecture

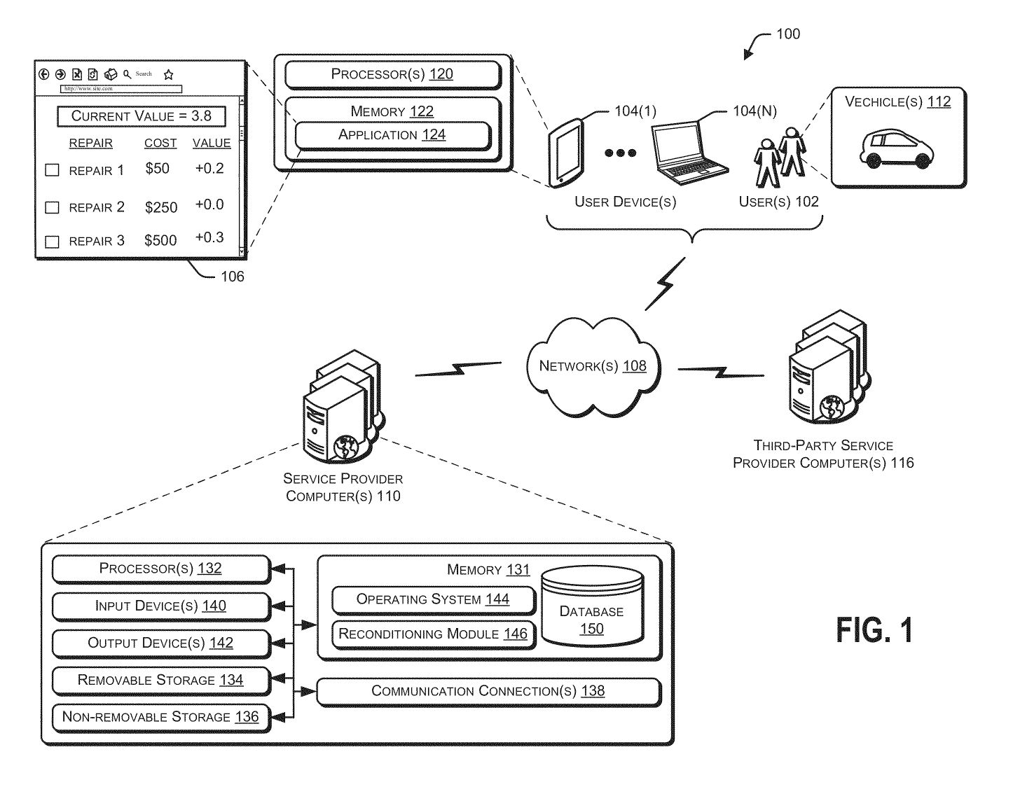

FIG. 1 illustrates an example system 100 for determining a change in the overall value of a vehicle based on implementing one or more possible repairs to the vehicle, according to an example embodiment. As depicted in FIG. 1, the system 100 may include, among other things, a service provider computer 110, one or more user devices 104, and one or more third party computers 116. In addition, one or more users 102 (e.g., sellers) may utilize the computing devices 104 to access one or more user application interfaces (or websites) 106 that may be provided by, created by, or otherwise associated with a service provider via one or more networks 108. In some instances, the computing devices 104 may be configured to present or otherwise display the user application interface 106 to the one or more users 102. Additionally, each of the aforementioned devices may be in communication with each other as well as with the service provider computer 110 over a network 108, such as the Internet or the like. Further, according to an example embodiment, the service provider computer 110 may be operated and/or controlled by a reconditioning management solution as described above.

While the illustrated example represents users 102 accessing the user application interface 106 over the networks 108, the described techniques may equally apply in instances where the users 102 interact with a service provider via a personal computer, over the phone, via a kiosk, or in any other manner. It is also noted that the described techniques may apply in other client/server arrangements (e.g., set-top boxes, etc.), as well as in non-client/server arrangements (e.g., locally stored software applications, etc.).

The user devices 104 may be any type of computing devices including, but not limited to, desktop personal computers (PCs), laptop PCs, mobile phones, smart phones, personal digital assistants (PDAs), tablets PCs, game consoles, set-top boxes, wearable computers, e-readers, web-enabled TVs, cloud-enabled devices and work stations, or the like. In some instances, each user device 104 may be equipped with one or more processors 120 and memory 122 to store applications and data, such as user application 124, that may display the user application interface 106 and/or enable access to the Web site 106 stored on the service provider computers 110 or elsewhere. In other instances, each user device 104 may include a browser or dedicated application that may perform some of the operations while the service provider computer 110 performs the others.

The service provider computers 110 may be any type of computing devices such as, but not limited to, mobile, desktop, and/or cloud computing devices, such as servers. In some examples, the service provider computers 110 may be in communication with the user devices 104 via the networks 108 or via other network connections. The service provider computers 110 may include one or more servers, perhaps arranged in a cluster, as a server farm, or as individual servers not associated with one another. These servers may be configured to host a website 106 viewable via the user application 124 or any other Web browser accessible by a user 102 such as, but not limited to, one or more of the user devices 104.

In some aspects, the user application interface 106 may allow the users 102 to access, receive from, transmit to, or otherwise interact with the service provider via the one or more service provider computers 110. For example, in some examples, the user application interface 106 may allow the users 102 to interact with the service provider via the one or more service provider computers 110 to determine and/or evaluate a cost benefit analysis based on implementing repairs or combinations of repairs (and their associated costs) to a damaged vehicle 112. In this manner, the users 102 may make an informed decision on which repairs or combination of repairs to implement to meet the users 102 objectives. Alternatively, or in addition to, the users 102 may define one or more parameters (such as costs, sales price, profits, CPO certification, time, or the like) and the service provider computers 110 may determine which repairs or combination of repairs to implement to meet the users 102 objectives within the defined parameters. The users 102 may evaluate one vehicle 112 at a time and/or groups of vehicles 112 collectively.

In certain embodiments, information associated with damage to a vehicle 112 may be provided to the service provider computers 110. For example, the information may be provided to the service provider computers 110 by the users 102 (e.g., by direct entry or gathered from the user's DMS or another user database), the one or more third party providers 116 (e.g., from one or more vehicle history report providers), or a combination thereof. In some instances, information about the vehicle inventory of the users 102 may also be provided to the service provider computers 110 by the users 102 (e.g., via an inventory management system), the one or more third party providers 116, or a combination thereof. In other instances, information about the repairs (such as cost and timing) may also be provided to the service provider computers 110 by the users 102, the one or more third party providers 116 (e.g., Mitchell pricing), or a combination thereof. In this manner, the users 102 and/or the service provider computers 110 may determine and/or evaluate a cost benefit analysis based on implementing repairs or combinations of repairs to one or more damaged vehicles 112 in the context of an entire inventory or subset thereof of damaged vehicles 112. Similarly, the data on which repairs will likely result in the fastest vehicle sale (e.g., most increase the odds of a sale the first time through the lane) may be included.

When a user 102, potentially operating one or more user devices 104, desires to identify vehicles for reconditioning in the user's inventory, the user 102 may access the service provider computer 110 over the network 108 via the devices 104. According to an example embodiment, the service provider computer 110, in response to a request, may assist the users 102 in evaluating the impact that one or more repairs or combinations of repairs may have on the overall value of a vehicle 112 or a group of vehicles 112 in inventory. To that end, the user 102 may be able to submit one or more parameters (such as cost, desired vehicle overall value, profitability, CPO certification, and/or timing, including impact on likelihood to sell) to guide or instruct the service provider computer 110 towards what types of repairs or combinations of repairs to identify for the vehicle 112 or the groups of vehicles 112 in inventory. Additionally, in some instances, the service provider computer 110 may also assist the user 102 with initiating the repairs or combinations of repairs by contacting a reconditioning shop. In another embodiment, the user 102 may define a set of repair parameters, and the service provider computer 110 may automatically determine (e.g., via one or more algorithms stored in memory 131) one or more repairs or combinations of repairs that meet the defined parameters. For example, the user 102 may define that if a conditioning score or grade of 3.5 can be achieved by spending $500.00 or less, the least expensive repairs or combinations of repairs should be automatically approved and the vehicle 112 should be automatically processed to a repair facility. In some instances, a report may be generated to document the repairs.

In one illustrative configuration, the service provider computer 110 comprises at least a memory 131 and one or more processing units (or processor(s)) 132. The processor(s) 132 may be implemented as appropriate in hardware, software, firmware, or combinations thereof. Software or firmware implementations of the processor(s) 132 may include computer-executable or machine-executable instructions written in any suitable programming language to perform the various functions described.

Memory 131 may store program instructions that are loadable and executable on the processor(s) 132, as well as data generated during the execution of these programs. Depending on the configuration and type of service provider computer 110, memory 131 may be volatile (such as random access memory (RAM)) and/or non-volatile (such as read-only memory (ROM), flash memory, etc.). The service provider computer 110 or server may also include additional removable storage 134 and/or non-removable storage 136 including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 131 may include multiple different types of memory, such as static random access memory (SRAM), dynamic random access memory (DRAM), or ROM.

The memory 131, the removable storage 134, and the non-removable storage 136 are all examples of computer-readable storage media. For example, computer-readable storage media may include volatile and non-volatile, removable and non-removable media implemented in any method or technology for storage of information such as computer-readable instructions, data structures, program modules, or other data. Memory 131, removable storage 134, and non-removable storage 136 are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tape, magnetic disk storage or other magnetic storage devices, or any other medium which can be used to store the desired information and which can be accessed by the service provider computer 110 or other computing devices. Combinations of any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The service provider computer 110 may also contain communication connection(s) 138 that allow the service provider computer 110 to communicate with a stored database, another computing device or server, user terminals, and/or other devices on a network. The service provider computer 110 may also include input device(s) 140 such as a keyboard, mouse, pen, voice input device, touch input device, etc., and output device(s) 142, such as a display, speakers, printers, etc.

Turning to the contents of the memory 131 in more detail, the memory 131 may include an operating system 144 and one or more application programs or services for implementing the features disclosed herein including a reconditioning module 146 and an information database 150. In some instances, the various modules, such as the reconditioning module 146, may receive, transmit, and/or store information in the information database 150. The reconditioning module 146 may be configured to receive, store, create, transmit, determine, and/or evaluate information associated determining a change in the overall value of a vehicle 112 or group of vehicles 112 in inventory based on implementing one or more possible repairs to the vehicles 112. For example, the reconditioning module 146 may be configured to have access to complete, or near compete, data associated with damage that exists on a vehicle 112 or groups of vehicles 112 that a user 102 would like to sell. As noted above, the damage data associated with a vehicle may be provided by one or more third parties 116 and/or by the user 102. Moreover, the reconditioning module 146 may have access to complete, or near compete, data associated with costs for making repairs to the damage. The repair cost data may come from the one or more third parties 116 and/or the users 102 may provide their own repair cost data. Further, the reconditioning module 146 may have access to complete, or near compete, data associated with repairs that are required by a certifying authority (such as an OEM or the like) for designating a vehicle 112 or as a CPO vehicle.

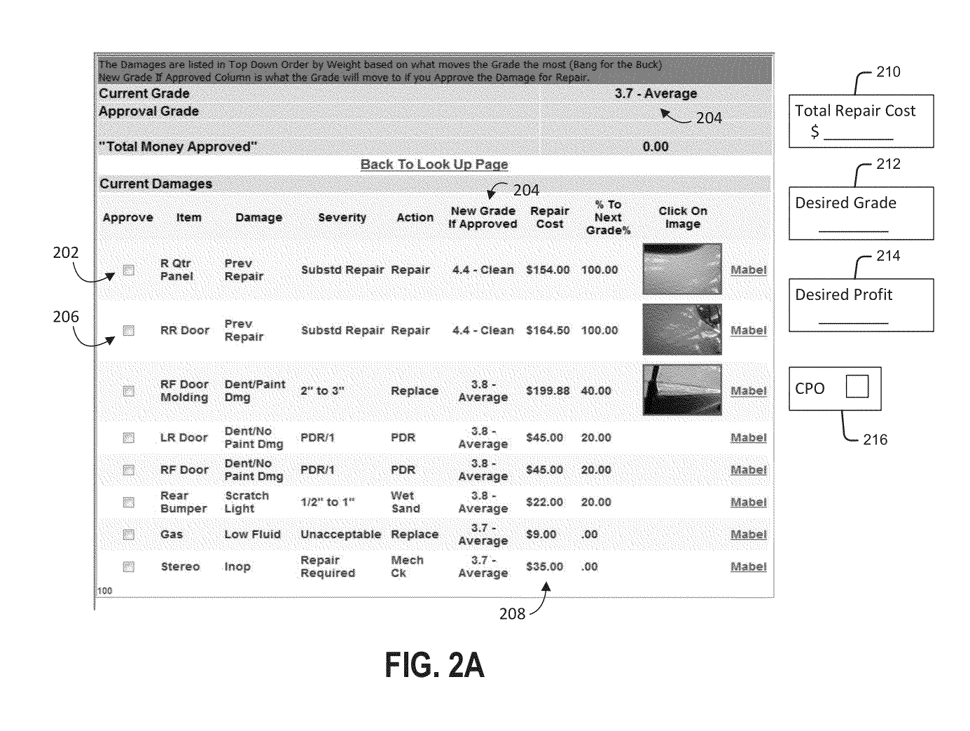

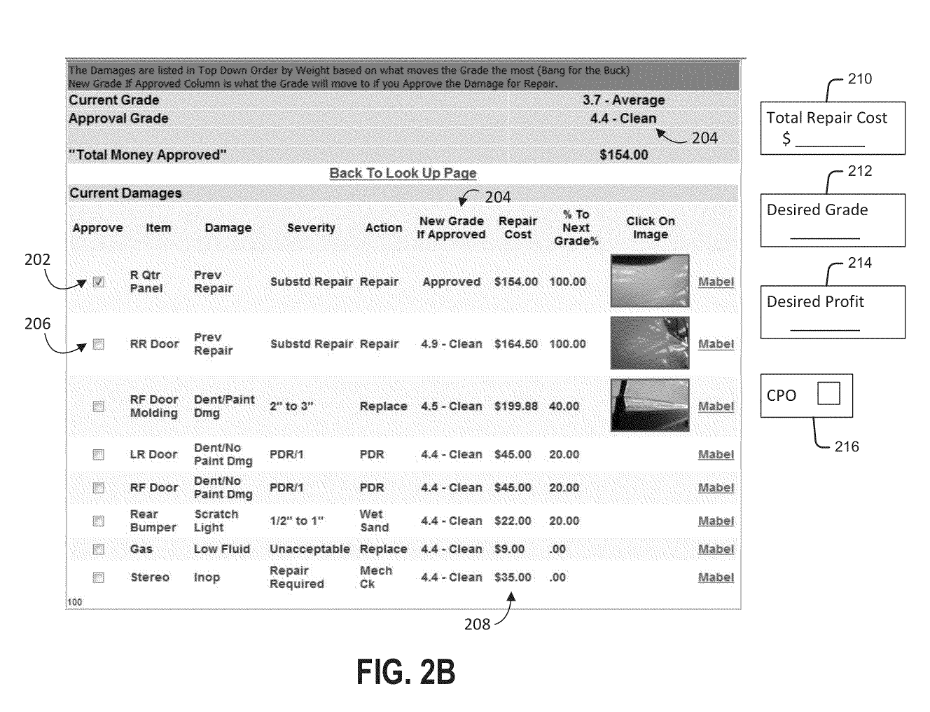

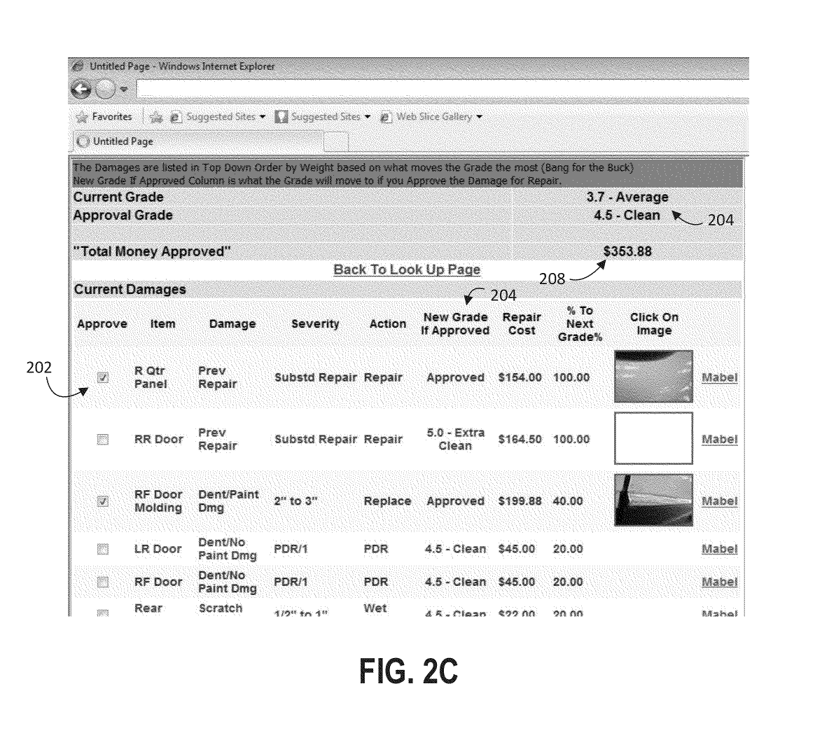

In certain embodiments, the user 102 may select, via the web application 106, one or more possible repairs or combinations of repairs to be done to the vehicle 112. The reconditioning module 146 may dynamically determine a change in the overall value of the vehicle 112 based on the selected possible repairs to the vehicle 112. For example, as collectively depicted in FIGS. 2A-2C, if the user 102 selects the repair 202 (listed in the first column as R Qtr Panel) the value (e.g., the condition score or grade 204) will improve from a 3.7 to a 4.4. In some instances, as the user 102 selects one or more repairs, the reconditioning module 146 may also dynamically adjust the impact that making other repairs will have on the overall value of the vehicle 112. For example, the repair 206 (listed in the first column as RR Door) may initially increase the conditioning score by 0.7. However, if the repair 202 is selected in combination with the repair 206, the repair 206 may only increase the conditioning score by 0.5 from 4.4 to 4.9. That is, a user 102 who makes both of those repairs will have a vehicle 112 that receives a condition score of 4.9. In this way, the user 102 can iteratively examine the impact of the various repairs or combinations of repairs on the value 204 of the vehicle 112 and then determine the repairs or combinations of repairs that they think are most appropriate in light of the price 208 for such repairs.

In certain embodiments, the reconditioning module 146 can be configured to determine, based on one or more parameters entered by the user 102, optimal repairs or combinations of repairs automatically for each vehicle 112 or for a group of vehicles 112. For example, the user 102 can enter a repair budget 210 (e.g., the total cost of repairs the user 102 is willing to spend on a vehicle 112 or a group of vehicles 112), and the reconditioning module 146 can then identify all of the possible repairs or combinations of repairs that can be made within the repair budget 210. The reconditioning module 146 can then provide a list of the repairs or combinations of repairs ranked by how much they increase the overall value 204, profitability 214 or condition score 204 of the vehicle 112 or the group of vehicles 112. That is, in some instances, the repair budget can be per vehicle, or it can be for all of the vehicles 112 in, for example, an inventory of the user 102 or a subset thereof.

Similarly, the user 102 can enter a target overall value 212 of a vehicle 112 or a group of vehicles 112, and the reconditioning module 146 can then identify all of the repairs or combinations of repairs that will raise the overall value of the vehicle 112 or the group of vehicles 112 to meet or exceed the target value 212. For example, the user 102 may enter a target value of 4.2 for a vehicle 112 or an average target value of 4.1 for a group of vehicle, and the reconditioning module 146 can then identify all of the repairs or combinations of repairs that will raise the overall value of the vehicle 112 to 4.2 or the average overall value of the group of vehicles 112 to 4.1. In some instances, the user 102 may select the target value 212 from a list provided by the reconditioning module 146 comprising typical target values (e.g., at wholesale auction or retail) for the same or similar vehicle makes and models. If, however, the selected target value 212 is not possible, the reconditioning module 146 may rank the repairs or combinations of repairs in the order that come closest to achieving the target value 212. In some instances, the repairs or combinations of repairs can be listed and ranked by the cost associated with the repairs or combinations of repairs, the total number of repairs, and/or how long the repairs or combinations of repairs will take to complete. Further, the reconditioning module 146 can be configured to identify and provide the sellers with a list of repairs or combinations of repairs that most improve the profitability 214 of the vehicle 112 or the group of vehicles 112.

In certain embodiments, the user 102 can indicated that they wish to repair the vehicle 112 to CPO standards 216. In response, the reconditioning module 146 may be configured to identify all of the repairs or combinations of repairs that are required for designating the vehicle 112 as a CPO vehicle. Moreover, the reconditioning module 146 may identify an overall value 212 of the vehicle 112 in order to meet CPO standards.

Various instructions, methods, and techniques described herein may be considered in the general context of computer-executable instructions, such as program modules, executed by one or more computers or other devices. Generally, program modules include routines, programs, objects, components, data structures, etc., for performing particular tasks or implementing particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on some form of computer-readable storage media.

The example system 100 and service provider computer 110 shown in FIG. 1 are provided by way of example only. Numerous other operating environments, system architectures, and device configurations are possible. Accordingly, embodiments of the present disclosure should not be construed as being limited to any particular operating environment, system architecture, or device configuration.

### Illustrative Processes

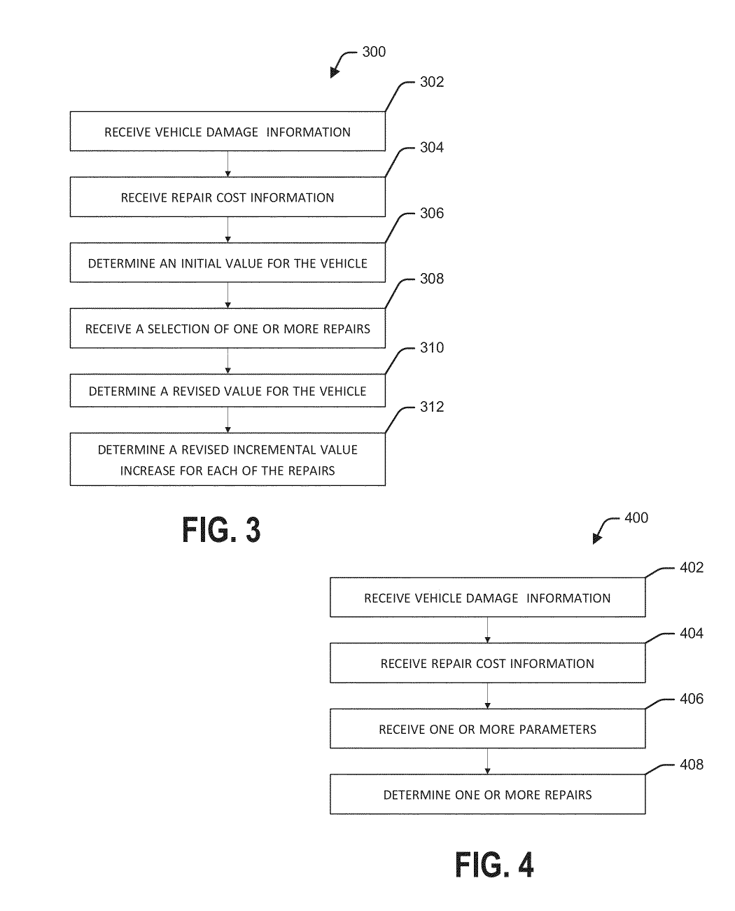

FIG. 3 is a flow diagram of an illustrative process 300 for determining a change in the overall value of a vehicle based on implementing one or more possible repairs to the vehicle, as described with reference to FIG. 1. The illustrative process 300 may be utilized to enable sellers to appreciate and evaluate the impact that one or more repairs or combinations of repairs may have on the overall value of a vehicle 112. In certain embodiments, the service provider computer 102 may perform any or all of the operations of process 300.

This process 300 is illustrated as a logical flow graph, in which each operation represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

In this particular implementation, the process 300 may begin at block 302 in which the process 300 may receive vehicle damage information, such as, for example, data that details damage that exists on a vehicle 112 that a seller 102 would like to sell. As noted above, the damage data may be provided by one or more third parties, such as a vehicle history report provider, a condition report or inspection or it may be provided by the seller 102. The damage data may be received, identified, or determined from any number of sources. At block 304, the process 300 may receive repair cost information. That is, data may be received that indicates the costs associated with making repairs to the damage. The repair costs may come from third parties, such as Mitchell pricing, or it may come from the seller 102, or it could come from a database of historical repair information (e.g., from Manheim's reconditioning departments or from any other suitable source(s)). For example, some sellers 102 may have their own repair facilities as well as their own database of proprietary repair cost data that they may want to use in assessing the impact of making repairs. The repair costs may be received, identified, or determined from any number of sources.

At block 306, the process 300 may determine an initial value for the vehicle 112. According to an example embodiment, the initial value may be determined based on the condition of the vehicle (including all damage associated with the vehicle) and other factors, such as, but not limited to, the year, the make, the model, trim, options, and/or the mileage of the vehicle 112. For example, the service provider computer 102 may have access to one or more vehicle valuation reports, such as MMR or Kelly Blue Book, and may determine the initial value of the vehicle 112 based on said reports. In other instances, the initial valuation of the vehicle 112 may be based on a proprietary algorithm and/or measure, such as a condition score. The initial value of the vehicle 112 may take into account any number of factors. Moreover, the initial value may be received, identified, or determined from any number of sources.

The process 300, at block 308, may receive a selection of one or more repairs. That is, in certain embodiments, the sellers 102 may select, via the web application 106, one or more possible repairs or combinations of repairs to be done to the vehicle 112. For example, each repair may include an associated modifier (such as an incremental value increase) that implementing the repair will have on the overall value of the vehicle 112. Moreover, each repair may include an associated cost. Accordingly, the seller 102 may select one or more possible repairs to be done to the vehicle 112 and iteratively work through which repairs or combinations of repairs are cost effective. In some instances, the reconditioning management solution 146 described herein may identify, present, suggest, and/or recommend one or more possible repairs to the seller 102 prior to receiving a selection of repairs from the seller 102. In some instances, one or more repairs may be identified and/or selected in order to bring the vehicle 112 into compliance with CPO standards 216. In certain aspects, the seller may filter (or limit) the repairs identified, presented, suggested, and/or recommended by the reconditioning management solution 146.

At block 310, the process 300 may determine a revised value for the vehicle 112. For example, the overall value may be revised based on the selected repairs to the vehicle 112. That is, the modifier (e.g., the incremental value increase) associated with each selected repair may be added to the initial value of the vehicle 112. At block 312, the process 300 may determine a revised modifier (e.g., incremental value increase) for each of possible the repairs. For example, in some instances, as the seller 102 selects one or more repairs, the incremental value increase associated with each nonelected repair may be adjusted (or revised) as other repairs are selected. In this manner, the impact that making other repairs will have on the overall value of the vehicle 112 may change as one or more repairs are selected. This enables the seller 102 to iteratively examine the impact of the various repairs or combinations of repairs and then determine the repairs or combinations of repairs that they think are most appropriate.

FIG. 4 is a flow diagram of an illustrative process 400 for determining possible repairs or combinations of repairs to implement on a vehicle 112, as described with reference to FIG. 1. The illustrative process 400 may be utilized to enable sellers 102 to set various parameters and identify repairs or combinations of repairs to meet said parameters. In certain embodiments, the service provider computer 102 may perform any or all of the operations of process 400.

This process 400 is illustrated as a logical flow graph, in which each operation represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

In this particular implementation, the process 400 may begin at block 402 in which the process 400 may receive vehicle damage information, such as, for example, data that details damage that exists on a vehicle 112 that a seller 102 would like to sell. As noted above, the damage data may be received, identified, or determined from any number of sources. At block 404, the process 400 may receive repair cost information. That is, data may be received that indicates the costs associated with making repairs to the damage. As noted above, the repair costs may be received, identified, or determined from any number of sources.

The process 400 may receive one or more parameters at block 406. For example, in certain embodiments, the seller 102 can enter one or more parameters, such as a repair budget, a target value for the vehicle, a CPO certification, and/or a desired profit. Other parameters may also be entered and/or selected. Based on the parameters, the process 400 may determine one or more repairs at block 408. That is, the process 400 may identify all of the possible repairs or combinations of repairs that can be made within the parameters. For example, all of the possible repairs or combinations of repairs that can be made within the repair budget may be determined The repairs and/or combinations of repairs may be presented to the user 102 and/or automatically approved by the service provider computer 110 and a repair facility can be automatically notified.

In certain embodiments, the process 400 may be scalable from an individual vehicle to an inventory of vehicles or subset thereof. That is, the seller 102 can indicate that they want all of their vehicles to be a minimum value, all repairs or combinations of repairs for each vehicle 112 or a group of vehicles 112 to be within a maximum cost, all vehicles to be CPO, and/or the overall profitability of each vehicle 112 or a group of vehicles 112 to be a certain percentage. In this manner, all of the vehicles 112 in the inventory may be analyzed and a determination of how to best achieve the parameters set by the seller may be made. Again, the repairs and/or combinations of repairs may be presented to the user 102 and/or automatically approved by the service provider computer 110 and a repair facility can be automatically notified.

Illustrative systems and methods of for evaluating repairs or combinations of repairs on the overall value of a vehicle are described above. Some or all of these systems and methods may, but need not, be implemented at least partially by an architecture such as that shown in FIG. 1. It should be understood that certain acts in the methods need not be performed in the order described, may be rearranged or modified, and/or may be omitted entirely, depending on the circumstances. Also, any of the acts described above with respect to any method may be implemented by a processor or other computing device based on instructions stored on one or more computer-readable storage media.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

That which is claimed:

1. A method, comprising:
receiving, by one or more computers comprising one or more processors, information regarding damage associated with at least one vehicle;
receiving, by the one or more computers, information regarding repair costs associated with one or more repairs related to addressing the damage associated with the at least one vehicle;
determining, by the one or more computers and based at least in part on the damage associated with the at least one vehicle, an initial value of the at least one vehicle;
receiving, by the one or more computers, an indication of a selection of at least one of the one or more repairs; and
determining, by the one or more computers and based at least in part on the selected one or more repairs, a revised value of the at least one vehicle.

2. The method of claim 1, further comprising determining, by the one or more computers, an initial value modifier associated with each of the one or more repairs.

3. The method of claim 2, further comprising determining, by the one or more computers and based at least in part on the selection of at least one of the one or more repairs, a revised value modifier for the one or more repairs.

4. The method of claim 1, further comprising receiving, by the one or more computers, an indication to remove at least one of the one or more repairs from consideration.

5. The method of claim 1, further comprising identifying, by the one or more computers, at least one of the one or more repairs to receive CPO certification for the at least one vehicle.

6. The method of claim 1, wherein the damage associated with the at least one vehicle is provided by at least one of: one or more third parties; a seller of the at least one vehicle; and/or an inspector who performs a vehicle condition inspection.

7. The method of claim 1, wherein the repair costs are provided by at least one of: one or more third parties; and/or a seller of the at least one vehicle.

8. The method of claim 1, wherein the initial value and/or revised value comprise at least one of: a wholesale and/or retail monetary value for the at least one vehicle; a desired wholesale and/or retail profit for the at least one vehicle; and/or a condition score or grade for the at least one vehicle.

9. The method of claim 1, wherein the at least one vehicle comprises a plurality of vehicles.

10. A system, comprising:
at least one memory that stores computer-executable instructions; and
at least one processor configured to access the at least one memory, wherein the at least one processor is configured to execute the computer-executable instructions to:
receive information regarding damage associated with at least one vehicle;
receive information regarding repair costs associated with one or more repairs related to addressing the damage associated with the at least one vehicle;
receive one or more parameters; and
determine, based at least in part on the one or more parameters and the repair costs, at least a portion of the one or more repairs to be implemented to the at least one vehicle.

11. The system of claim 10, wherein the at least one vehicle comprises a plurality of vehicles.

12. The system of claim 10, wherein the one or more parameters comprise at least one of:
a repair budget for the at least one vehicle or a group of vehicles; a target value for the at least one vehicle or a group of vehicles; a desired profit for the at least one vehicle or a group of vehicles; a CPO certification for the at least one vehicle or a group of vehicles; and/or a condition score for the at least one vehicle or a group of vehicles.

13. A non-transitory computer-readable medium storing instructions that when executed by one or more processors, cause the one or more processors to:
receive information regarding damage associated with at least one vehicle;
receive information regarding repair costs associated with one or more repairs related to addressing the damage associated with the at least one vehicle;
determine, based at least in part on the damage associated with the at least one vehicle, an initial value of the at least one vehicle;
receive an indication of a selection of at least one of the one or more repairs; and
determine, based at least in part on the selected one or more repairs, a revised value of the at least one vehicle.

14. The non-transitory computer-readable medium of claim 13, further comprising instructions that cause the one or more processors to determine an initial value modifier associated with each of the one or more repairs.

15. The non-transitory computer-readable medium of claim 14, further comprising instructions that cause the one or more processors to determine, based at least in part on the selection of at least one of the one or more repairs, a revised value modifier for the one or more repairs not selected.

16. The non-transitory computer-readable medium of claim 13, further comprising instructions that cause the one or more processors to receive an indication to remove at least one of the one or more repairs from consideration.

17. The non-transitory computer-readable medium of claim 13, further comprising instructions that cause the one or more processors to identify at least one of the one or more repairs to receive CPO certification for the at least one vehicle.

18. The non-transitory computer-readable medium of claim 13, wherein the damage associated with the at least one vehicle is provided by at least one of: one or more third parties; a seller of the at least one vehicle; and/or an inspector who performs a vehicle condition inspection.

19. The non-transitory computer-readable medium of claim 13, wherein the repair costs are provided by at least one of: one or more third parties; and/or a seller of the at least one vehicle.

20. The non-transitory computer-readable medium of claim 13, wherein the initial value and/or revised value comprise at least one of: a wholesale and/or retail monetary value for the at least one vehicle; a desired wholesale and/or retail profit for the at least one vehicle; and/or a condition score or grade for the at least one vehicle.
